(19) United States
(12) Patent Application Publication
(10) Pub. No.: US 2007/0110308 A1
(43) Pub. Date: May 17, 2007

(54) Method, medium, and system with category-based photo clustering using photographic region templates

(75) Inventors: Euihyeon Hwang, Goyang-si (KR); Sangkyun Kim, Yongin-si (KR); Jiyeun Kim, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-Si (KR)

(21) Appl. No.: 11/477,374

(22) Filed: Jun. 30, 2006

(30) Foreign Application Priority Data
Nov. 17, 2005 (KR) 10-2005-0110372

(51) Int. Cl. G06K 9/00; G06K 9/62; H04N 5/76

(52) U.S. Cl. 382/170; 382/155; 382/224; 348/231.3

(57) ABSTRACT

A category-based photo clustering method, medium, and system using region division templates. The method may include dividing an input photo into regions by using photo region templates, modeling a local semantic concept that the photo includes in each divided region, extracting a dominant concept of each region from the modeling, generating a histogram of dominant concepts, and determining a category that the photo has from the histogram. According to a method, medium, and system, by using together user preference and content-based feature value information, such as color, texture, and shape, from the contents of photos, as well as information that can be basically obtained from photos, such as camera information and file information stored in a camera, a large volume of photos may be categorized such that an album can be generated and accessed fast and effectively.

### CROSS-REFERENCE TO RELATED APPLICATIONS

This application claims the priority benefit of Korean Patent Application No.10-2005-0110372, filed on Nov. 17, 2005, in the Korean Intellectual Property Office, the disclosure of which is incorporated herein in its entirety by reference.

### BACKGROUND OF THE INVENTION

1. Field of the Invention

Embodiments of the present invention relate at least to a digital photo album, and more particularly, to a category-based photo clustering method, medium, and system using region division templates.

2. Description of the Related Art

Ordinary digital photo albums are used to organize photos taken by a user, e.g., from a digital camera or a memory card, in a local storage. Generally, by using such a photo album, users can index many photos based upon their date and time or according to photo categories arbitrarily defined by the users. The users may then browse the photos based on the index, or share the photos with other users.

In particular, clustering photos based on categories is one of the major functions of photo albums. Such categorization reduces searching when retrieving photos desired by a user, while improving the accuracy and speed of the searching. Further, if the classifying of the photos into user desired categories is automatically performed, it becomes easier for the user to manage a large volume of photos in an album.

Most of the conventional categorization methods are text based, using text meta data of each picture as singularly specified/entered one by one by a user. However, these text-based methods are not useful in that if there are a large number of photos, it becomes almost impossible for a user to specify all category information for each of the photos, one by one. In addition, text information is not very effective in describing semantic concepts within the photos. Accordingly, a method of categorizing multimedia contents, by using content-based features, such as colors, shapes, and texture, extracted based on the contents of photos has been suggested.

Here, research has been made into clustering photos by using content-based features within the photo images. However, since each photo includes a variety of semantic concepts, the automatic extraction of multiple semantic concepts has been difficult. To solve this problem, there has been research into extracting major objects within a photo (image) and based on the concepts of these major objects, indexing or categorizing the photos. However, since extracting a variety of semantic concepts included in a photo is very difficult, only major semantic concepts have been extracted through this method.

The subject of such research has focused in particular on extracting main subjects among semantic objects included in a photo and identifying and indexing the corresponding object for categorizing the photo. That is, in the categorizing of photos, research has focused on segmentation of objects included in a photo and indexing or categorizing the segmented object.

However, in most of photo image cases there are typically a lot of semantic concepts included in each photo image, such that categorization based on extracting the main subject results in the loss of the other semantic concepts.

Generally, photos are divided into a foreground and a background. In the categorization of photo data, the semantic concept included in the foreground is important but the semantic concept included in the background is also important.

Accordingly, as a method of categorizing photo data, there is a need for a method to extract a variety of semantic concepts included in a photo by considering both the concepts of the foreground and the background.

### SUMMARY OF THE INVENTION

Embodiments of the present invention provide a category-based clustering method, medium, and system using region division templates to extract a variety of semantic concepts included in a photo, based on content-based features of the photo within the different templates, and to automatically classify the photo into a variety of categories. The photo data may be effectively divided into regions, with the semantic concept of each of the divided region being extracted, and through efficient merging of the local semantic concept of the region the semantic concept included in the photo can be categorized.

Additional aspects and/or advantages of the invention will be set forth in part in the description which follows and, in part, will be apparent from the description, or may be learned by practice of the invention.

To achieve the above and/or other aspects and advantages, embodiments of the present invention include a category-based photo clustering method, including modeling local semantic concepts for template based regions within an image, extracting dominant concepts of respective regions based on the modeled local semantic concepts for the respective regions, generating a histogram of the dominant concepts of the respective regions, and determining a category of the image based on the histogram.

The method may further include dividing the image into different regions based upon predefined region templates.

In addition, there may be 10 predefined region templates, and if the image has dimensions of width w and length h, coordinates of each region division templates, as applied to the image, are expressed according to:
T(t)={left(t),top(t), right(t), bottom(t)}

Here, left(t) is an x coordinate of a left side of a t-th template, top(t) is a y coordinate of a top side of the t-th template, right (t) is the x coordinate of a right side of the t-th template, and bottom (t) is the y coordinate of a bottom side of the t-th template, and coordinates of the 10 templates are expressed by:

$$\begin{matrix}T ( 1 ) = \{ \frac{w}{4} , \frac{h}{4} , \frac{3 w}{4} , \frac{3 h}{4} \} ; \\ T ( 2 ) = \{ 0 , 0 , \frac{w}{2} , \frac{h}{2} \} ; \\ T ( 3 ) = \{ \frac{w}{2} , 0 , w , \frac{h}{2} \} ; \\ T ( 5 ) = \{ \frac{w}{2} , \frac{h}{2} , w , h \} ; \\ T ( 6 ) = \{ 0 , 0 , w , \frac{h}{2} \} , \\ T ( 7 ) = I \{ 0 , \frac{h}{2} , w , h \} ; \\ T ( 8 ) = \{ 0 , 0 , \frac{w}{2} , h \} ; \\ T ( 9 ) = \{ \frac{w}{2} , 0 , w , h \} , \\ T ( 10 ) = \{ 0 , 0 , w , h \} .\end{matrix}$$

The predefined templates may overlap.

In addition, the modeling of the local semantic concepts may include extracting respective content-based feature values in each of the respective regions, and obtaining local concept response values, indicating a correlation between a local semantic concept and a corresponding content-based feature value, for each of the respective regions, for each local semantic concept.

In the extraction of the respective content-based feature values, a color, texture, and shape information within the respective regions may be used. In addition, in the extraction of the respective content-based feature values, moving picture experts group (MPEG)-7 descriptors of the image may be used to extract the feature values. Still further, in the obtaining of the local concept response values, the local semantic concept may include an item (Lentity) indicating an entity of a semantic concept included in the image and an item (Lattribute) indicating an attribute of the entity of the semantic concept.

Further, in the extracting of the dominant concepts, the local concept response values of the respective regions may be classified in descending order, and with respect to a size of a response value, dominant concepts are extracted. Here, the determination of the category of the image may be performed based on a rule-based histogram model. The determination of the category of the image may also be performed based on a training-based histogram model.

In the modeling of the local semantic concepts, a discrete boost algorithm may be used to model local concepts of the regions. In the discrete boost algorithm, by using a mean value of each element of a positive example vector and a negative example vector, a moving range of a threshold may be estimated, and through a boosting technique, weight values and thresholds may be trained.

To achieve the above and/or other aspects and advantages, embodiments of the present invention include a category-based photo clustering system, the system including a local semantic concept modeling unit to model local semantic concepts for template based regions within an image, a dominant concept extraction unit to extract dominant concepts of respective regions based on the modeled local semantic concepts for the respective regions, a histogram generation unit to generate a histogram of the dominant concepts of the respective regions, and a category determination unit to determine a category of the image based on the histogram.

The system may further include a region division unit to divide the image into different regions based upon predefined templates.

There may be 10 predefined region templates, and if the image has dimensions of width w and length h, coordinates of each region division templates, as applied to the image, may be expressed according to:
T(t)={left(t),top(t),right(t),bottom(t)}

Here, left(t) is an x coordinate of a left side of a t-th template, top(t) is a y coordinate of a top side of the t-th template, right (t) is the x coordinate of a right side of the t-th template, and bottom (t) is the y coordinate of a bottom side of the t-th template, and coordinates of the 10 templates are expressed by:

$$\begin{matrix}T ( 1 ) = \{ \frac{w}{4} , \frac{h}{4} , \frac{3 w}{4} , \frac{3 h}{4} \} ; \\ T ( 2 ) = \{ 0 , 0 , \frac{w}{2} , \frac{h}{2} \} ; \\ T ( 3 ) = \{ \frac{w}{2} , 0 , w , \frac{h}{2} \} ; \\ T ( 5 ) = \{ \frac{w}{2} , \frac{h}{2} , w , h \} ; \\ T ( 6 ) = \{ 0 , 0 , w , \frac{h}{2} \} , \\ T ( 7 ) = I \{ 0 , \frac{h}{2} , w , h \} ; \\ T ( 8 ) = \{ 0 , 0 , \frac{w}{2} , h \} ; \\ T ( 9 ) = \{ \frac{w}{2} , 0 , w , h \} , \\ T ( 10 ) = \{ 0 , 0 , w , h \} .\end{matrix}$$

The predefined templates may also overlap.

The semantic concept modeling unit may include a feature value extraction unit to extract respective content-based feature values in each of the respective regions, and a response value calculation unit to obtain local concept response values, indicating a correlation between a local semantic concept and a corresponding content-based feature value, for each of the respective regions, for each local semantic concept.

In the extraction of the respective content-based feature values, a color, texture, and shape information within the respective regions may be used. Moving picture experts group (MPEG)-7 descriptors of the image may also be used to extract the feature values. Still further, the local semantic concept may include an item (Lentity) indicating an entity of a semantic concept included in the image and an item (Lattribute) indicating an attribute of the entity of the semantic concept.

The dominant concept extraction unit may classify the local concept response values obtained in the respective regions in descending order, and with respect to a size of a response value, extracts dominant concepts. The determination of the category of the image, in the category determination unit, may be performed based on a rule-based histogram model. The determination of the category of the image, in the category determination unit, may also be performed based on a training-based histogram model.

In the modeling of the local semantic concepts, a discrete boost algorithm may be used to model local concepts of the regions. In the discrete boost algorithm, by using a mean value of each element of a positive example vector and a negative example vector, a moving range of a threshold may be estimated, and through a boosting technique, weight values and thresholds may be trained.

To achieve the above and/or other aspects and advantages, embodiments of the present invention include at least one medium including computer readable code to implement embodiments of the present invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a category-based photo clustering system using region division templates, according to an embodiment of the present invention;

FIG. 2 illustrates region division templates for a photo, according to embodiments of the present invention;

FIG. 3 illustrates examples of photo division performed in a region division unit, such as that of FIG. 1, according to an embodiment of the present invention;

FIG. 4 illustrates a structure of a local semantic concept modeling unit, such as that of FIG. 1, according to an embodiment of the present invention;

FIG. 5 illustrates an example of entity concepts of a divided region and attribute concepts expressing the attributes of the entity concept, according to an embodiment of the present invention;

FIG. 6 illustrates a category-based photo clustering method using region division templates, according to an embodiment of the present invention;

FIG. 7 illustrates local semantic concept modeling, according to an embodiment of the present invention;

FIG. 8 illustrates a training process of a classifier, according to an embodiment of the present invention;

FIG. 9 illustrates positive example vectors, negative example vectors, and threshold values, according to an embodiment of the present invention;

FIG. 10 illustrates K content-based features, T regions, and a concept histogram, according to an embodiment of the present invention;

FIG. 11 illustrates frequencies of local concepts, according to an embodiment of the present invention;

FIG. 12 illustrates a method of determining a category of an entire photo by using a rule-based histogram model, according to an embodiment of the present invention; and

FIG. 13 illustrates training-based histogram model for determining a category of a photo, according to an embodiment of the present invention.

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. Embodiments are described below to explain the present invention by referring to the figures.

According to an embodiment of the present invention, as a method of extracting a semantic concept from a photo, after dividing an image into regions, a semantic concept of each region can be extracted.

Here, if the image is divided into regions, it becomes easier to extract a single semantic concept from each region, but if the size of the divided regions become too small, it may become difficult to extract even a single semantic concept from each region. That is, determining the size by which an image is to be divided is not an easy task.

Accordingly, in order to extract a semantic concept of a photo there is a need for effective image division and the extracting of accurate semantic concepts from the divided image regions.

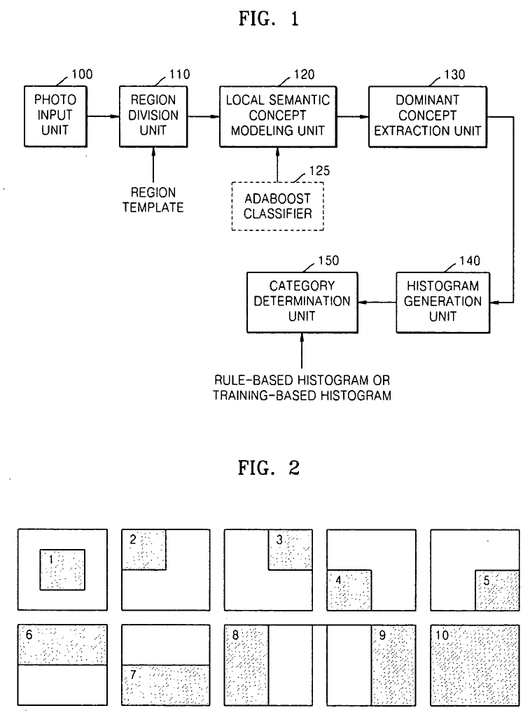

First, FIG. 1 illustrates a category-based photo clustering system using region division templates, according to an embodiment of the present invention. The system may include a region division unit 110, a local semantic concept modeling unit 120, a dominant concept extraction unit 140, a histogram generation unit 160, and a category determination unit 180, for example. In an embodiment of the present invention, the category-based photo clustering system may further include a photo input unit 100.

The photo input unit 100 may receive an input of a photo stream from an internal memory apparatus of a digital camera or a portable memory apparatus, for example, noting that alternative embodiments are equally available. The photo data may be based on ordinary still image data, and the format of the photo data may include an image data format, such as joint photographic experts group (JPEG), TIFF and RAW formats, noting that the format of the photo data is not limited to these examples.

Accordingly, the region division unit 110 may divide the input photo into regions by using photo region division templates.

FIG. 2 illustrates region division templates of a photo, according to embodiments of the present invention. Embodiments of the present invention may include division of a photo into 10 base templates, as shown in FIG. 2. The 10 region division base templates may, further, be expressed according to the following Equation 1.

Equation 1:
T={T(t)|t ε 10} (1)

Here, T(t) is a t-th region division template.

If the input photo I has dimensions of width w and length h, coordinates of each of the region division templates may be expressed according to the following Equation 2.

Equation 2:
T(t)={left(t),top(t), right(t), bottom(t) (2)

Here, left(t) is the x coordinate of the left side of the t-th template, top(t) is the y coordinate of the top side of the t-th template, right (t) is the x coordinate of the right side of the t-th template, and bottom (t) is the y coordinate of the bottom side of the t-th template. According to Equation 2, coordinates of each of the templates may still further be expressed according to the following Equations 3.

$$\begin{matrix}Equations 3 \text{:} & ( 3 ) \\ \begin{matrix}T ( 1 ) = \{ \frac{w}{4} , \frac{h}{4} , \frac{3 w}{4} , \frac{3 h}{4} \} ; \\ T ( 2 ) = \{ 0 , 0 , \frac{w}{2} , \frac{h}{2} \} ; \\ T ( 3 ) = \{ \frac{w}{2} , 0 , w , \frac{h}{2} \} ; \\ T ( 5 ) = \{ \frac{w}{2} , \frac{h}{2} , w , h \} ; \\ T ( 6 ) = \{ 0 , 0 , w , \frac{h}{2} \} , \\ T ( 7 ) = I \{ 0 , \frac{h}{2} , w , h \} ; \\ T ( 8 ) = \{ 0 , 0 , \frac{w}{2} , h \} ; \\ T ( 9 ) = \{ \frac{w}{2} , 0 , w , h \} , \\ T ( 10 ) = \{ 0 , 0 , w , h \} .\end{matrix} & \end{matrix}$$

The input photo I, divided according to the region division templates, may, thus, be expressed according to the following Equation 4.

Equation 4:
I={I(T)|T ε T} (4)

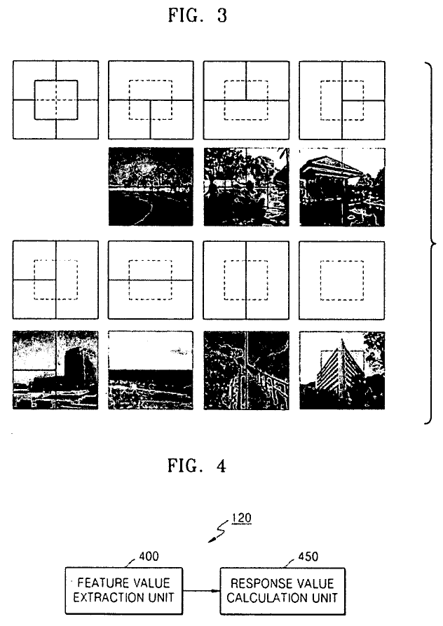

FIG. 3 illustrates examples of photo division performed by a region division unit, such as that of FIG. 1, according to an embodiment of the present invention. Referring to FIG. 3, it can be seen that there may be a local semantic concept in each of the divided regions. For example, in the first illustrated photo, it can be seen that the sky is positioned along the top of the image, a riverside is positioned along the bottom left corner, and the bottom right corner of the image includes a lawn. That is, the semantic concept information in the differing regions of the photo are clear.

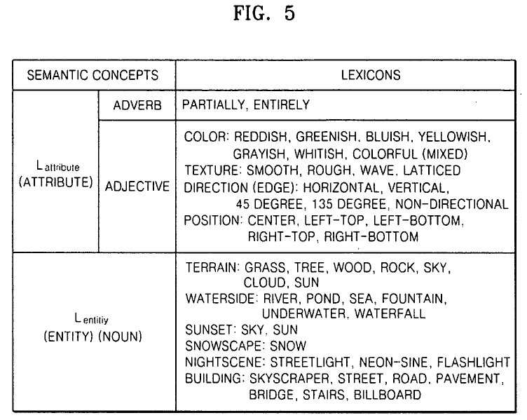

The local semantic concept modeling unit 120 may model a local semantic concept from each of the divided regions of the photo. FIG. 4 illustrates the local semantic concept modeling unit 120, which may include a feature value extraction unit 400 and a response value calculation unit 450. The feature value extraction unit 400 may extract a content-based feature value in each divided region. Here, the extraction of the content-based feature value may be based on the color, texture, and shape information within a region of the image, and may further extract feature values by using MPEG-7 descriptors, for example. The multiple content-based feature values may be expressed according to the following Equation 5.

Equation 5:
F={F(f)|f ε N_{f}} (5)

Here, N_{f} is the number of user feature values.

Embodiments of the present invention extract content-based feature values using, again only as an example, color, texture, and shape information of an image as basic features, and basically extract feature values by using an MPEG-7 descriptor. It is noted that the extracting of the content-based feature values is not limited to the MPEG-7 descriptor.

Multiple content-based feature values extracted from a divided region, divided by template T, may be expressed according to the following Equation 6.

Equation 6:
F_{T}={F_{T}(f)|f ε N_{f}} (6)

Embodiments of the present invention include modeling of a local semantic concept within each of the divided regions based on the given region-based feature values.

For this, first, local semantic concepts that may be within a target category of category-based clustering may be defined. A local semantic concept, Llocal, can include Lentity, which is an item indicating the entity of a semantic concept included in a photo, and Lattribute, which is an item indicating the attribute of the entity of a semantic concept. FIG. 5 illustrates an example of entity concepts of a divided region and attribute concepts expressing the attributes of the entity concept, according to an embodiment of the present invention.

Lentity may be expressed according to the following Equation 7.

Equation 7:
L_{entity}={L_{entity}(e)|e ε Nₑ} (7)

Here, L_{entity} is an e-th entity semantic concept, and Nₑ is the number of defined entity semantic concepts.

Lattribute may be expressed according to the following Equation 8.

Equation 8:
L_{attribute}={L_{attribute}(a) |a ε Nₐ} (8)

Here, L_{attribute} (a) is an a-th attribute semantic concept, and Nₐ is the number of defined attribute semantic concepts.

The local semantic concept Llocal may, thus, be expressed according to the following Equation 9.

Equation 9:
L_{local}={L_{entity},L_{attribute}}={L(l)|l ε (Nₑ+Nₐ)} (9)

Here, L(l) is an l-th semantic concept, and can be an entity semantic concept or an attribute semantic concept.

The response value calculation unit 450 may calculate a local concept response value, which indicates the correlation between a local semantic concept and the content-based feature value, for each local semantic concept. By using a discrete boost algorithm, the local concept of the input photo divided into regions can be modeled. By using the mean value of each element of a positive example vector and a negative example vector, the moving range of a threshold may be estimated, and through a boosting technique weight values and thresholds can be trained.

The dominant concept extraction unit 140 may extract the dominant concept of differing regions, from the modeling. More specifically, the dominant concept extraction unit 140 may classify the local concept response values, obtained in respective regions, in descending order and with respect to the size of the response value, dominant concepts may, thus, be extracted.

The histogram generation unit 160 may generate a histogram of the dominant concepts, and the category determination unit 180 may determine a category that the photo may be a member of, from the histogram.

In the category determination, a rule-based histogram or a training-based histogram may be used, for example.

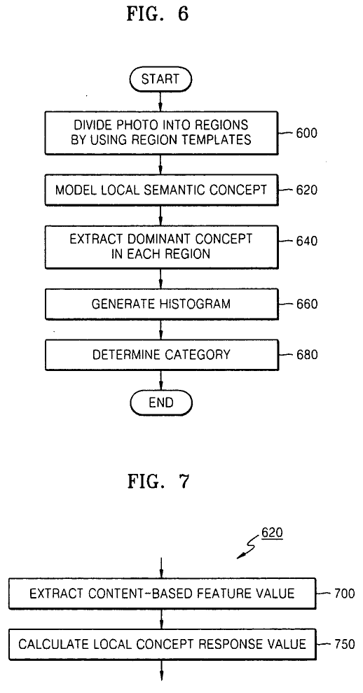

FIG. 6 illustrates a category-based photo clustering method using region division templates, according to an embodiment of the present invention.

Here, if a photo is input, the photo may be divided into regions by using photo region division templates, in operation 600. A local semantic concept for each of the divided photo regions may be modeled, in operation 620.

FIG. 7 further illustrates a local semantic concept modeling, according to an embodiment of the present invention. The local semantic concept modeling may be performed by extracting multiple content-based feature values from each of the divided regions, in operation 700. Then, a local concept response value, which indicates the correlation between a local semantic concept and the content-based feature value for each region, may be calculated in relation to each local semantic concept, in operation 750.

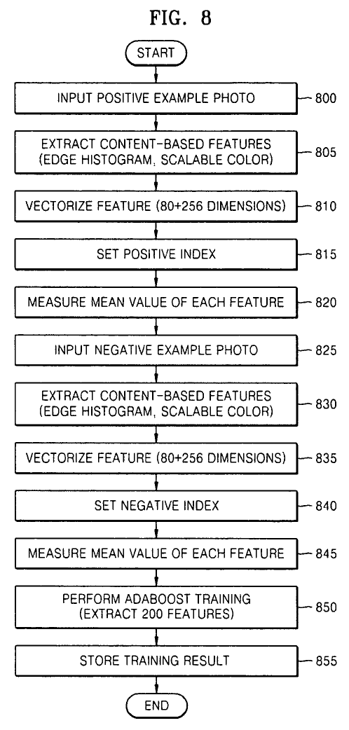

The local semantic concept modeling may use a boost algorithm. More specifically, it may use an AdaBoost classifier. The classifier has a training database and uses a discrete boost algorithm. The training database may include, for example, a night view, a scene, a building photo, and their negative example images. Also, an 80-dimension edge histogram and a 256-dimension scalable color may be used, with the dimensions being expandable. FIG. 8 illustrates a training process of the classifier, according to an embodiment of the present invention. Broadly, the classifier learns with respect to the inputs of positive example photos and negative example photos.

First, if a positive example photo is input, in operation 800, a content-based feature may be extracted, in operation 805, and the feature may then be vectorized, in operation 810. The content-based feature may be an edge histogram and a scalable color, for example. The feature vector may be 80 dimensions of the edge histogram and 256 dimensions of the scalable color, as another example. Then, a positive index may be set, in operation 815, and the mean value of each feature measured, in operation 820.

Next, if a negative example photo is input, in operation 825, a content-based feature may be extracted, in operation 830, and the feature vectorized, in operation 835.

In the same manner as in the positive example photo, the content-based feature may be an edge histogram and a scalable color. The feature vector may be 80 dimensions of the edge histogram and 256 dimensions of the scalable color. Then, a negative index may be set, in operation 840, and the mean value of each feature measured, in operation 845. Then, AdaBoost training may be is performed, in operation 850, and training result stored, in operation 855.

In a discrete boost algorithm, by using the mean value of each element of the positive example vector and the negative example vector, the moving range of a threshold may be estimated and then, a weight value (α) and a threshold for each element are trained.

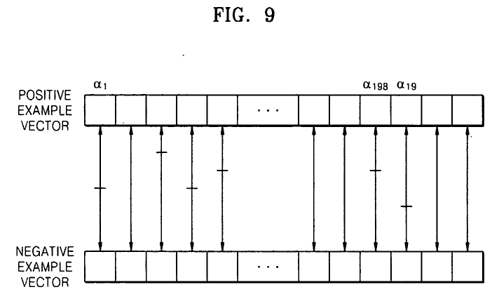

FIG. 9 illustrates examples of positive example vectors, negative example vectors, and threshold values, according to an embodiment of the present invention. In FIG. 9, the horizontal line segment on each arrow with two arrowheads indicates a threshold value.

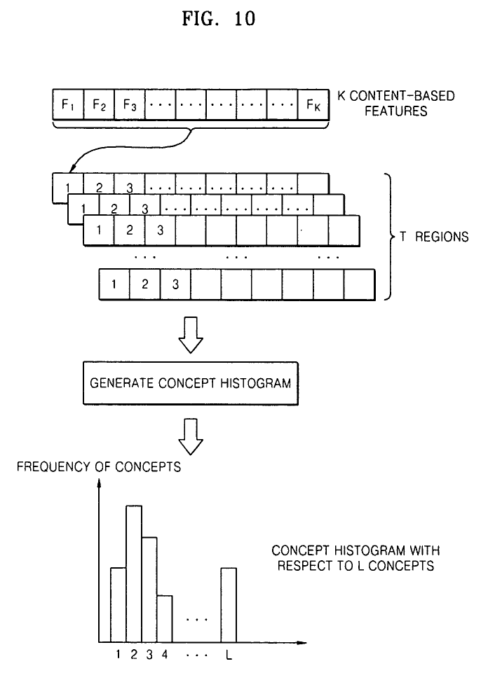

FIG. 10 illustrates K content-based features, T regions, and a concept histogram, according to an embodiment of the present invention.

If the response value of each local concept is calculated through the local semantic concept modeling, in operation 750, a dominant concept may be extracted in relation to each region, in operation 640. For the extraction of the dominant concept for each region, local concept response values for each region may be classified in descending order, for example, and with respect to the size of the response value, also for example, dominant concepts are extracted and determined. The local concept response values may further be classified in descending order with a local concept showing the highest response value being recorded, and when necessary, with local concepts showing the second and third highest response values also being recorded.

Table 1, below, shows an example in relation to extraction of dominant concepts.

TABLE 1

| Local | | | | | | | | | | |
|---|---|---|---|---|---|---|---|---|---|---|
| concept | Tree | Land | Water | Sun | . . . | Rock | Sky | Cloud | Window | Bush |
| First region | 1.254 | 0.817 | −1.352 | −0.244 | . . . | 1.122 | 0.132 | −0.58 | −0.276 | 1.311 |

In Table 1, the local concept ‘bush’ shows the highest response value, with the ‘tree’ showing the second highest, and the ‘rock’ showing the third highest. Accordingly, the first region may be identified as relating to a ‘bush.’ When necessary, if it is decided to determine response values showing the second and third highest response values as dominant concepts, the ‘tree’ and ‘rock’ identifiers may also be identified as dominant concepts.

Table 2, below, shows the case where the top three values, in relation to the first region, are considered. Accordingly, as Table the 2, top three major local concepts may be extracted in all regions, for example.

TABLE 2

| Region | Dominant concept 1 | Dominant concept 2 | Dominant concept 3 |
|---|---|---|---|
| First | Bush | Tree | Rock |
| Second | Bush | Rock | Tree |
| . . . | . . . | . . . | . . . |
| T-th | Water | Cloud | Land |

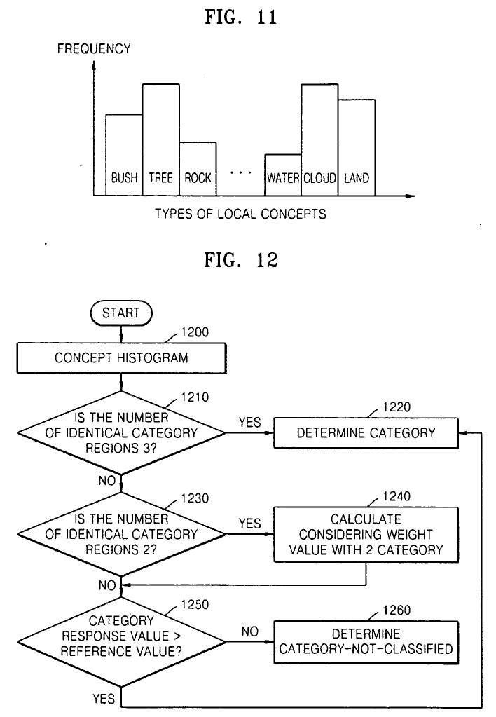

If a dominant concept for each region is extracted, a histogram may be generated, in operation 660. For example, dominant concepts may be extracted as shown in Table 2, and by using the result, the frequency of each concept may be calculated and a histogram, as shown in FIG. 11, may be generated.

By using a histogram, categories corresponding to the entire photo may be determined, in operation 680. The determination of the category may use a rule-based histogram model or a training-based histogram model, for example.

FIG. 12 illustrates a method of determining a category for an entire photo by using a rule-based histogram model, according to an embodiment of the present invention. A predetermined rule may be generated in each category and if the number of regions is 3, for example, the category of the entire photo may be determined by using the rule shown in FIG. 12.

Referring to FIG. 12, the determination of a category for the entire photo will now be further explained. First, if a concept histogram is generated, in operation 1200, it is determined whether or not the number of identical categories for respective regions of the photo is 3, in operation 1210. If the number of identical category regions is 3, the category for the entire photo may be determined to be that identical category, in operation 1220. If the number of regions of identical categories is 2, in operation 1230, calculation may be performed by applying weight values to the two category response values, in operation 1240. If the result value is greater than a predetermined reference value, in operation 1250, the category for the entire image may be determined to correspond to that corresponding category, in operation 1220, or else the category of the entire photo may remain un-defined or determined to be category-not-classified, in operation 1260, for example.

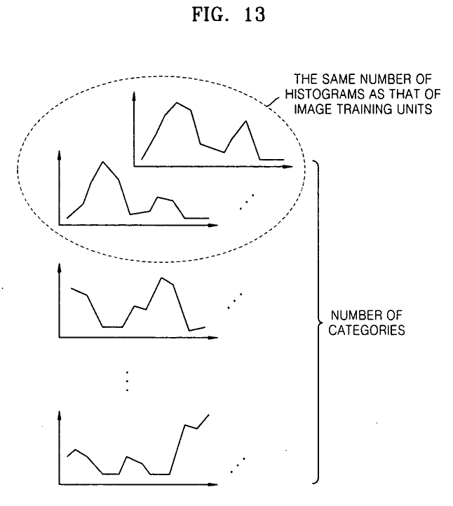

As shown in FIG. 13, histograms may be grouped in relation to each category and trained through a classifier, such as a support vector machine (SVM) or Boosting. By doing so, a corresponding category can be determined for a new histogram input.

In addition to the above described embodiments, embodiments of the present invention can also be implemented through computer readable code/instructions in/on a medium, e.g., a computer readable medium. The medium can correspond to any medium/media permitting the storing and/or transmission of the computer readable code.

The computer readable code can be recorded/transferred on a medium in a variety of ways, with examples of the medium including magnetic storage media (e.g., ROM, floppy disks, hard disks, etc.), optical recording media (e.g., CD-ROMs, or DVDs), and storage/transmission media such as carrier waves, as well as through the Internet, for example. The media may also be a distributed network, so that the computer readable code is stored/transferred and executed in a distributed fashion.

According to the above category-based clustering method, medium, and system, by using together user preference and content-based feature value information, such as color, texture, and shape, from within photos, as well as information that can be basically obtained from photos, such as camera information and file information stored in a camera, a large volume of photos may be effectively categorized. Such categorization can enable generation and access of the album to be faster and more effective.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A category-based photo clustering method, the method comprising:
modeling local semantic concepts for template based regions within an image;
extracting dominant concepts of respective regions based on the modeled local semantic concepts for the respective regions;
generating a histogram of the dominant concepts of the respective regions; and
determining a category of the image based on the histogram.

2. The method of claim 1, further comprising dividing the image into different regions based upon predefined region templates.

3. The method of claim 2, wherein there are 10 predefined region templates, and if the image has dimensions of width w and length h, coordinates of each region division templates, as applied to the image, are expressed according to:
T(t)={left(t),top(t), right(t), bottom(t)}
where left(t) is an x coordinate of a left side of a t-th template, top(t) is a y coordinate of a top side of the t-th template, right (t) is the x coordinate of a right side of the t-th template, and bottom (t) is the y coordinate of a bottom side of the t-th template, and coordinates of the 10 templates are expressed by:
$$\begin{matrix}T ( 1 ) = \{ \frac{w}{4} , \frac{h}{4} , \frac{3 w}{4} , \frac{3 h}{4} \} ; \\ T ( 2 ) = \{ 0 , 0 , \frac{w}{2} , \frac{h}{2} \} ; \\ T ( 3 ) = \{ \frac{w}{2} , 0 , w , \frac{h}{2} \} ; \\ T ( 5 ) = \{ \frac{w}{2} , \frac{h}{2} , w , h \} ; \\ T ( 6 ) = \{ 0 , 0 , w , \frac{h}{2} \} , \\ T ( 7 ) = I \{ 0 , \frac{h}{2} , w , h \} ; \\ T ( 8 ) = \{ 0 , 0 , \frac{w}{2} , h \} ; \\ T ( 9 ) = \{ \frac{w}{2} , 0 , w , h \} , \\ T ( 10 ) = \{ 0 , 0 , w , h \} .\end{matrix}$$

4. The method of claim 2, wherein the predefined templates overlap.

5. The method of claim 1, wherein the modeling of the local semantic concepts comprises:
extracting respective content-based feature values in each of the respective regions; and
obtaining local concept response values, indicating a correlation between a local semantic concept and a corresponding content-based feature value, for each of the respective regions, for each local semantic concept.

6. The method of claim 5, wherein, in the extraction of the respective content-based feature values, a color, texture, and shape information within the respective regions are used.

7. The method of claim 5, wherein, in the extraction of the respective content-based feature values, moving picture experts group (MPEG)-7 descriptors of the image are used to extract the feature values.

8. The method of claim 5, wherein, in the obtaining of the local concept response values, the local semantic concept comprises an item (Lentity) indicating an entity of a semantic concept included in the image and an item (Lattribute) indicating an attribute of the entity of the semantic concept.

9. The method of claim 5, wherein, in the extracting of the dominant concepts, the local concept response values of the respective regions are classified in descending order, and with respect to a size of a response value, dominant concepts are extracted.

10. The method of claim 9, wherein the determination of the category of the image is performed based on a rule-based histogram model.

11. The method of claim 9, wherein the determination of the category of the image is performed based on a training-based histogram model.

12. The method of claim 1, wherein, in the modeling of the local semantic concepts, a discrete boost algorithm is used to model local concepts of the regions.

13. The method of claim 12, wherein, in the discrete boost algorithm, by using a mean value of each element of a positive example vector and a negative example vector, a moving range of a threshold is estimated, and through a boosting technique, weight values and thresholds are trained.

14. A category-based photo clustering system, the system comprising:
a local semantic concept modeling unit to model local semantic concepts for template based regions within an image;
a dominant concept extraction unit to extract dominant concepts of respective regions based on the modeled local semantic concepts for the respective regions;
a histogram generation unit to generate a histogram of the dominant concepts of the respective regions; and
a category determination unit to determine a category of the image based on the histogram.

15. The system of claim 14, further comprising:
a region division unit to divide the image into different regions based upon predefined templates.

16. The system of claim 15, wherein there are 10 predefined region templates, and if the image has dimensions of width w and length h, coordinates of each region division templates, as applied to the image, are expressed according to:
T(t)={left(t),top(t), right(t), bottom(t)}
where left(t) is an x coordinate of a left side of a t-th template, top(t) is a y coordinate of a top side of the t-th template, right (t) is the x coordinate of a right side of the t-th template, and bottom (t) is the y coordinate of a bottom side of the t-th template, and coordinates of the 10 templates are expressed by:
$$\begin{matrix}T ( 1 ) = \{ \frac{w}{4} , \frac{h}{4} , \frac{3 w}{4} , \frac{3 h}{4} \} ; \\ T ( 2 ) = \{ 0 , 0 , \frac{w}{2} , \frac{h}{2} \} ; \\ T ( 3 ) = \{ \frac{w}{2} , 0 , w , \frac{h}{2} \} ; \\ T ( 5 ) = \{ \frac{w}{2} , \frac{h}{2} , w , h \} ; \\ T ( 6 ) = \{ 0 , 0 , w , \frac{h}{2} \} , \\ T ( 7 ) = I \{ 0 , \frac{h}{2} , w , h \} ; \\ T ( 8 ) = \{ 0 , 0 , \frac{w}{2} , h \} ; \\ T ( 9 ) = \{ \frac{w}{2} , 0 , w , h \} , \\ T ( 10 ) = \{ 0 , 0 , w , h \} .\end{matrix}$$

17. The system of claim 15, wherein the predefined templates overlap.

18. The system of claim 14, wherein the semantic concept modeling unit comprises:
a feature value extraction unit to extract respective content-based feature values in each of the respective regions; and
a response value calculation unit to obtain local concept response values, indicating a correlation between a local semantic concept and a corresponding content-based feature value, for each of the respective regions, for each local semantic concept.

19. The system of claim 18, wherein, in the extraction of the respective content-based feature values, a color, texture, and shape information within the respective regions are used.

20. The system of claim 18, wherein, in the extraction of the respective content-based feature values, moving picture experts group (MPEG)-7 descriptors of the image are used to extract the feature values.

21. The system of claim 18, wherein the local semantic concept comprises an item (Lentity) indicating an entity of a semantic concept included in the image and an item (Lattribute) indicating an attribute of the entity of the semantic concept.

22. The system of claim 18, wherein the dominant concept extraction unit classifies the local concept response values obtained in the respective regions in descending order, and with respect to a size of a response value, extracts dominant concepts.

23. The system of claim 22, wherein the determination of the category of the image, in the category determination unit, is performed based on a rule-based histogram model.

24. The system of claim 22, wherein the determination of the category of the image, in the category determination unit, is performed based on a training-based histogram model.

25. The system of claim 14, wherein, in the modeling of the local semantic concepts, a discrete boost algorithm is used to model local concepts of the regions.

26. The system of claim 25, wherein, in the discrete boost algorithm, by using a mean value of each element of a positive example vector and a negative example vector, a moving range of a threshold is estimated, and through a boosting technique, weight values and thresholds are trained.

27. At least one medium comprising computer readable code to implement the method of claim 1.
